(19) United States
(12) Patent Application Publication
(10) Pub. No.: US 2026/0093823 A1
(43) Pub. Date: Apr. 2, 2026

(54) COMPUTER-IMPLEMENTED METHOD FOR OBTAINING ACCESS NOTIFICATION AS PART OF TAINT ANALYSIS WHEN TESTING A SOFTWARE PROGRAM, SYSTEM, COMPUTER PROGRAM, AND COMPUTER-READABLE MEDIUM

(71) Applicant: Robert Bosch GmbH, Stuttgart (DE)

(72) Inventors: Christopher Huth, Heilbronn (DE); Max Camillo Eisele, Ludwigsburg (DE)

(21) Appl. No.: 19/336,768

(22) Filed: Sep. 23, 2025

(30) Foreign Application Priority Data
Sep. 30, 2024 (DE) 10 2024 209 508.7

(51) Int. Cl. G06F 21/57; G06F 11/3698

(52) U.S. Cl. CPC G06F 21/577; G06F 11/3698; G06F 2221/031; G06F 2221/033

(57) ABSTRACT

A computer-implemented method for obtaining an access notification as part of a taint analysis when testing a software program. The software program is executed on a hardware target. The hardware target has a memory. During execution of the software program, the software program stores data at least in part of the memory. The method includes: generating input data for the software program by means of a test module; transmitting the generated input data to the software program by means of the test module; monitoring at least one address of the memory by means of a debugger while the software program at least partially processes the transmitted input data; transmitting an access notification to the test module if at least one access is detected at the at least one address of the monitored memory.

### BACKGROUND INFORMATION

Taint analysis is a method used in information security to identify the flow of user inputs through a system and to understand the security implications for system design. This analysis aims to mitigate risks, such as SQL injection, which generally arise when other parts of the program use user input without proper sanitization. Many programming languages, such as Ruby, have built-in taint analysis mechanisms. Variables that have received user input are marked as “tainted.” Any variable derived from them is also marked as “tainted.” Using this trace, the analysis tool can create a list of infected variables. If a critical operation, such as a database call or an operating system-level call, uses suspicious variables, the testing tool can alert the developer to a potential security risk.

Taint analysis is used to track the flow of information in software programs and can be combined with fuzzing to detect potential information leaks. There is basically no easy solution for runtime environments or languages that do not support taint analysis, in particular not for embedded devices.

Taint analysis can detect the leakage of private data and the unintentional processing of untrusted data. However, the necessary information flow tracking may require sophisticated code instrumentation or dynamic analysis. Both are typically difficult to apply to embedded system program code. Microcontrollers, the key components of embedded systems, usually lack sufficient program memory, have low-throughput data connections, and differ in many ways.

Germany Patent Application No. DE 10 2021 212 596 A1 describes a computer-implemented method for obtaining software coverage feedback when fuzzing software on a hardware target, wherein the hardware target has at least one watchpoint register and is configured to halt an execution of the software before executing an instruction of the software if the instruction is reached during execution of the software and a memory address of the instruction is set in the at least one breakpoint register, comprising setting a first breakpoint before a first instruction of the software; executing or continuing a fuzzing iteration of the software; first checking whether the first breakpoint is reached when executing or continuing the fuzzing iteration; storing first log information comprising that the first instruction in the fuzzing iteration has been reached, and, optionally, deleting the first breakpoint if the first check is positive. The software coverage feedback during software fuzzing comprises the first log information.

### SUMMARY

In a first aspect of the present invention, a computer-implemented method is provided for obtaining an access notification as part of a taint analysis when testing a software program that is executed on a hardware target. The hardware target has a memory, wherein, during execution of the software program, the software program stores data at least in part of the memory.

According to an example embodiment of the present invention, the method comprises the steps described below. The steps described can in particular be carried out in the specified order. However, a different order is also possible in principle. Furthermore, it is possible that two or more of the method steps are carried out in a temporally overlapping manner or simultaneously. Furthermore, it is possible that one or more of the method steps are carried out once or a plurality of times. The method may comprise further method steps which are not shown. For the disclosure relating to this aspect, any further aspect, embodiment and/or definition may be referenced and/or referred to.

The term “testing” as used herein is a broad term which should be given its ordinary and common meaning as understood by a person skilled in the art. The term is not limited to any specific or adapted meaning. The term may, without limitation, refer in particular to an automated process for testing the software program, i.e., software. Testing may involve multiple test iterations. During a test iteration, input data are generated for the software program to be tested, i.e., the software target. The software program is executed with these input data. During a test iteration, the software program is monitored. In this monitoring, software coverage feedback can be generated from the software, which is then forwarded to the fixed module. In a subsequent test iteration, further input data can be generated based on this software coverage feedback. The test module can be a fuzzer, which fuzzer generates the input data.

The term “hardware target” as used herein is a broad term which should be given its ordinary and common meaning as understood by a person skilled in the art. The term is not limited to any specific or adapted meaning. The term may, without limitation, refer in particular to hardware that acts as an embedded system and on which the software program is executed. The hardware target may in particular be designed as a microcontroller.

The term “taint analysis” as used herein is a broad term which should be given its ordinary and common meaning as understood by a person skilled in the art. The term is not limited to any specific or adapted meaning. The term may, without limitation, refer in particular to a technique of security analysis and program verification used to identify vulnerabilities and potential security risks in the software program. In taint analysis, insecure data (tainted data) are made available to the software program as input data, wherein the software program tracks the data flow of the input data and of the data influenced by the input data and thus potentially identified. As explained above, the input data can be generated by means of the test module. Dynamic taint analysis allows the data flow of the software program to be monitored in real time during its execution.

According to an example embodiment of the present invention, the method comprises the following steps, which can represent a first test iteration:
generating input data for the software program by means of a test module;
transmitting the generated input data to the software program by means of the test module;
monitoring at least one address of the memory by means of a debugger while the software program at least partially processes the transmitted input data;
transmitting an access notification to the test module if at least one access is detected at the at least one address of the monitored memory.

The exclusive use of generic debugging functions makes it possible to use the method according to the present invention on a variety of hardware targets and independently of the programming languages and instruction sets used.

The term “generating input data” as used herein is a broad term which should be given its ordinary and common meaning as understood by a person skilled in the art. The term is not limited to any specific or adapted meaning. The term may, without limitation, refer to the process of generating input data. The input data can be generated by means of the test module. When generating the input data, the test module can rely on a known input corpus with known input data, wherein the test module generates new input data from the known input corpus. The test module can take the change notification into account when generating input data, especially the additional input data, so that the generated input data are generated depending on the change notification. New input data can be generated for each test module iteration, each of which takes into account at least the most recently transmitted change notification.

The term “transmitting the generated input data,” or also code coverage, as used herein is a broad term which should be given its ordinary and common meaning as understood by a person skilled in the art. The term is not limited to any specific or adapted meaning. The term may, without limitation, refer to the process of transferring the generated input data from the test module to the software program. The transmitted input data can be processed by the software program. Typically, a host computer is provided on which the test module is executed. The host computer may have an interface, in particular a physical interface. Furthermore, the hardware target can have an interface, in particular a physical interface. The input data can be transmitted by means of these interfaces.

The term “monitoring at least one address of the memory” as used herein is a broad term which should be given its ordinary and common meaning as understood by a person skilled in the art. The term is not limited to any specific or adapted meaning. The term may, without limitation, refer to the process of continuously monitoring and controlling the at least one of the at least one address of the memory. In particular, the monitoring can be carried out in such a way that access to the address of the memory can be detected.

The at least one address of the memory may correspond to an address of the memory at which sensitive data are stored. The sensitive data may comprise at least one of the following data:
at least one secret key;
personal data,
intellectual property,
at least one sensitive model,
at least one sensitive configuration,
at least one certificate,
at least one access token,
at least one log,
at least one password, preferably a hashed password.

For example, sensitive data in binary form, such as secret keys, can be found by searching for memory addresses with high entropy.

The term “sensitive data” as used herein is a broad term which should be given its ordinary and common meaning as understood by a person skilled in the art. The term is not limited to any specific or adapted meaning. The term may, without limitation, refer to information, the disclosure of which can be potentially harmful to a person, an organization and/or a system.

To monitor the at least one address of the memory, one or more data watchpoints of the debugger can be set at the at least one address of the memory. A “data watchpoint” can be a function of the debugger that monitors access to at least one part of the specified address of the memory. Typically, a memory size of at least one byte can be monitored by means of a data watchpoint. In order to monitor a data watchpoint by means of the debugger, the debugger may have an interface, in particular a physical interface, that couples to the memory of the hardware target. By means of the interface, the debugger can read at least part of the specified address of the memory.

The term “debugger” as used herein is a broad term which should be given its ordinary and common meaning as understood by a person skilled in the art. The term is not limited to any specific or adapted meaning. The term may, without limitation, refer to a device or software that can control the software program which is executed on the hardware target.

The debugger can provide one or more functions to control the software program. The one or more functions may be or comprise reading at least one register and/or memory value of the memory of the hardware target, pausing, stopping and/or starting the execution of the software program, in particular such that the software program can be executed in individual steps.

The term “transmitting an access notification to the test module” as used herein is a broad term and should be given its ordinary and common meaning as understood by a person skilled in the art. The term is not limited to any specific or adapted meaning. The term may, without limitation, refer to the process of transferring data to the test module, wherein the access notification indicates to the test module that access to the at least one address of the memory has been detected. The access notification can only be transmitted to the test module if access to at least one address of the memory has been detected. The access notification can be passed from the debugger to the test module. As explained above, the host computer may have an interface, in particular a physical interface. Furthermore, the debugger may have an interface, in particular a physical interface. The access notification can be transmitted by means of these interfaces.

According to an example embodiment of the present invention, to transmit the access notification to the test module, the method may further comprise the following step:
ascertaining, by means of the debugger, status information of the hardware target at the time at which access to the at least one address of the monitored memory is detected; the access notification being or comprising the status information read by the debugger.

The term “status information” as used herein is a broad term which should be given its ordinary and common meaning as understood by a person skilled in the art. The term is not limited to any specific or adapted meaning. The term may, without limitation, refer to data and/or at least one parameter that at least partially describe the current status or situation of the software program. The evaluation of status information obtained in a test iteration may contain information about the data flow within the software program. Furthermore, the evaluation of status information obtained in a plurality of test iterations may contain information about the data flow within the software program.

In order to read the status information of the hardware target by means of the debugger, the debugger can be instructed to transmit the memory contents and/or register contents to the host computer. For this to happen, at least one breakpoint and/or data watchpoint of the debugger may have been triggered beforehand.

To ascertain the status information of the hardware target, an access function that accesses the at least one address of the monitored memory can be read out by means of the debugger, the status information being or comprising the access function.

The term “access function” as used herein is a broad term which should be given its ordinary and common meaning as understood by a person skilled in the art. The term is not limited to any specific or adapted meaning. The term may, without limitation, refer to a method for accessing the values in an address of the monitored memory. The access function can describe the type of access to the values in an address of the monitored memory. The access function can be read access and/or write access.

To ascertain the status information of the hardware target, the stack content of the hardware target can be at least partially read out by means of the debugger, the status information being or comprising the partially read out stack content.

The term “stack” as used herein is a broad term which should be given its ordinary and common meaning as understood by a person skilled in the art. The term is not limited to any specific or adapted meaning. The term may, without limitation, refer to a stack memory. A stack can contain a dynamic data structure. The “stack content” can refer to the data stored in the stack.

In order to read the stack content of the hardware target by means of the debugger, the debugger can be instructed to transmit the memory contents and/or register contents to the host computer. For this to happen, at least one breakpoint and/or data watchpoint of the debugger may have been triggered beforehand.

The partially read stack content can be or comprise the active stack frame. The term “stack frame” as used herein is a broad term which should be given its ordinary and common meaning as understood by a person skilled in the art. The term is not limited to any specific or adapted meaning. The term may, without limitation, refer to the region within a stack occupied by a specific program section. The term “active stack frame” as used herein is a broad term which should be given its ordinary and common meaning as understood by a person skilled in the art. The term is not limited to any specific or adapted meaning. The term may, without limitation, refer to the stack frame being processed at the time the access to the at least one address of the monitored memory is detected.

To ascertain the status information about the hardware target, the execution of the software program is stopped by means of the debugger. After the status information of the hardware target has been read, the execution of the software program can be resumed by means of the debugger.

According to an example embodiment of the present invention, the method may further comprise:
generating additional input data for the software program by means of the test module, taking into account the access notification transmitted to the test module;
transmitting the generated additional input data to the software program by means of the test module;
further monitoring the at least one address of the memory by means of the debugger while the software program at least partially processes the transmitted input data;
transmitting a further access notification to the test module if at least one further access is detected at the at least one address of the monitored memory.

These steps can represent another test iteration. These steps can be repeated in one or more test iterations. These steps can be repeated until testing is aborted.

The test strategy of the test module may be chosen such that the test module generates the input data in such a way that the data flow of the sensitive data is maximized.

According to an example embodiment of the present invention, the method may further comprise:
determining whether a data security rule of the software program is violated by evaluating the access notification and/or the further access notification.

The result of this determination can be output during execution of or after the taint analysis.

The term “data security rule” as used herein is a broad term which should be given its ordinary and common meaning as understood by a person skilled in the art. The term is not limited to any specific or adapted meaning. The term may, without limitation, refer to at least one regulation specifying which access to specific data and/or data flows is permitted. The data security rule can be or comprise at least one defined access pattern that must be fulfilled or must not occur during execution. For example, a data security rule can ensure that untrusted input data fed in via an interface is first processed by a sanitization function before being forwarded to a database engine, for example. Alternatively or additionally, a data security rule can aim to ensure that access to sensitive data may only be granted through at least one specific function. This can comprise all functions in the call stack. In this way, it can be determined whether sensitive data are leaked during runtime.

According to an example embodiment of the present invention, the method may further comprise:
aborting the method of obtaining an access notification as part of a taint analysis when testing a software program if at least one of the following conditions is met:
   a violation of a data security rule of the software program was detected;
   a software coverage of the software program has reached or exceeded a lower threshold value;
   a specified number of input data were processed;
   a specified test period has elapsed;
   the method was aborted manually.

In a further aspect of the present invention, a system is provided. According to an example embodiment of the present invention, the system comprises:
a host computer on which the test module is executed;
a hardware debugger on which the debugger is running;
a hardware target, the hardware target preferably comprising or being a microcomputer,
wherein the system is configured to execute the computer-implemented method for obtaining an access notification as part of a taint analysis when testing a software program. For the disclosure relating to this aspect, any further aspect, embodiment and/or definition may be referenced and/or referred to.

In a further aspect of the present invention, a computer program is described which, when run on the system of the present invention described above, executes the method for obtaining an access notification as part of a taint analysis when testing a software program according to one of the example embodiments of the method of present invention disclosed herein. For the disclosure relating to this aspect, any further aspect, embodiment and/or definition may be referenced and/or referred to.

In a further aspect of the present invention, a computer-readable data carrier is provided on which a data structure is stored which, after being loaded into a working and/or main memory of the system, executes the method of the present invention for obtaining an access notification as part of a taint analysis when testing a software program. For the disclosure relating to this aspect, any further aspect, embodiment and/or definition may be referenced and/or referred to.

The terms “computer-readable data carrier” and “computer-readable storage medium” as used herein may refer in particular to non-transitory data storage devices, such as a hardware data storage medium, on which computer-executable instructions are stored. The computer-readable data carrier or the computer-readable storage medium may in particular be or comprise a storage medium such as a random-access memory (RAM) and/or a read-only memory (ROM).

### BRIEF DESCRIPTION OF THE DRAWINGS

Further optional details and features of the present invention result from the following description of preferred exemplary embodiments shown schematically in the figures.

FIG. 1 is a schematic view of a computer-implemented method for obtaining an access notification as part of a taint analysis when testing a software program, according to an example embodiment of the present invention.

FIG. 2 is a schematic view of a system according to an exemplary embodiment of the present invention.

### DETAILED DESCRIPTION OF EXAMPLE EMBODIMENTS

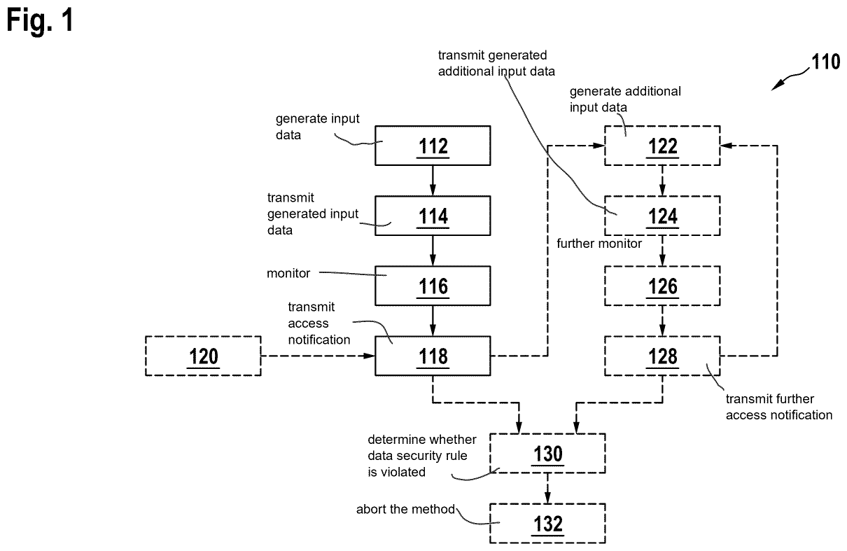

FIG. 1 shows a computer-implemented method for obtaining an access notification as part of a taint analysis when testing a software program 110, wherein the software program is executed on a hardware target 140, the hardware target 140 having a memory, wherein, during the execution of the software program, the software program stores data at least in part of the memory, the method comprising:
generating input data 112 for the software program by means of a test module;
transmitting the generated input data 114 to the software program by means of the test module;
monitoring at least one address of the memory 116 by means of a debugger 138 while the software program at least partially processes the transmitted input data;
transmitting an access notification 118 to the test module if at least one access is detected at the at least one address of the monitored memory.

The test module may comprise a fuzzer, which fuzzer generates the input data.

To transmit the access notification to the test module, the method may further comprise:
ascertaining status information of the hardware target 140 by means of the debugger 138 at the time at which the access to the at least one address of the monitored memory is detected;
the access notification being or comprising the status information read by the debugger 138.

To ascertain the status information of the hardware target 140, an access function that accesses the at least one address of the monitored memory can be read out by means of the debugger 138, the status information being or comprising the access function.

To ascertain the status information of the hardware target 140, the stack content of the hardware target 140 can be at least partially read out by means of the debugger 138, the status information being or comprising the partially read out stack content. The partially read stack content can be or comprise the active stack frame.

To ascertain the status information about the hardware target 140, the execution of the software program can be stopped by means of the debugger 138.

The at least one address of the memory may correspond to an address of the memory at which sensitive data are stored, in particular wherein the sensitive data comprise at least one of the following data:
at least one secret key;
personal data,
intellectual property,
at least one sensitive model,
at least one sensitive configuration,
at least one certificate,
at least one access token,
at least one log,
at least one password, preferably a hashed password.

To monitor the at least one address of the memory, one or more data watchpoints of the debugger 138 may be set at the at least one address of the memory.

The method 110 may further comprise:
generating additional input data 122 for the software program by means of the test module, taking into account the access notification transmitted to the test module;
transmitting the generated additional input data 124 to the software program by means of the test module;
further monitoring the at least one address of the memory 126 by means of the debugger 138 while the software program at least partially processes the transmitted input data;
transmitting a further access notification 128 to the test module if at least one further access is detected at the at least one address of the monitored memory.

The test strategy of the test module must be selected such that the test module generates the input data in such a way that the data flow of the sensitive data is maximized.

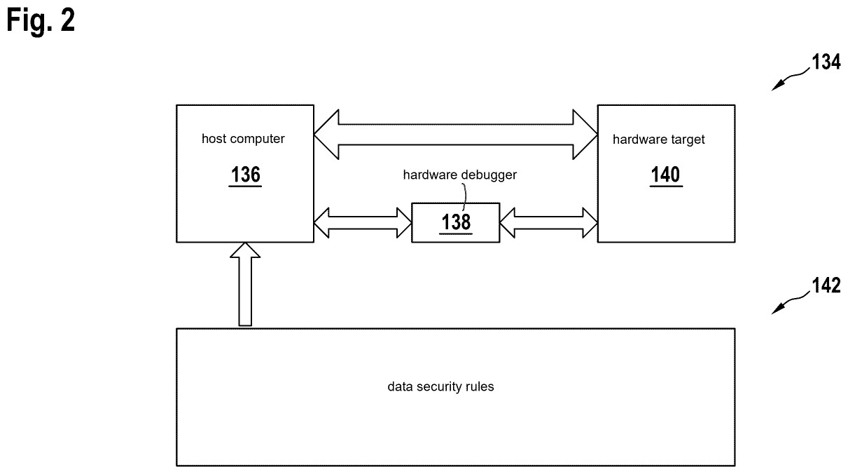

The method 110 may further comprise:
determining whether a data security rule 142 (see FIG. 2) of the software program is violated 130 by evaluating the access notification and/or the further access notification, in particular by means of the test module.

The method 110 may further comprise:
aborting the method 132 for obtaining an access notification as part of a taint analysis when testing a software program, in particular by means of the test module, if at least one of the following conditions is met:
   a violation of a data security rule of the software program was detected;
   a software coverage of the software program has reached or exceeded a lower threshold value;
   a specified number of input data were processed;
   a specified test period has elapsed;
   the method was aborted manually.

FIG. 2 shows an exemplary system 134, which system comprises:
a host computer 136 on which the test module is executed;
a hardware debugger 138 on which the debugger is executed;
a hardware target 140, the hardware target preferably comprising or being a microcomputer,
wherein the system is configured to execute the computer-implemented method for obtaining an access notification as part of a taint analysis when testing a software program. The system can be a hardware in the loop (HiL) system.

The data flow between the individual hardware components 136, 138, 140 can take place as shown by the arrows. The data flow can take place via appropriately configured physical interfaces. FIG. 2 also shows exemplary data security rules 142.

The data security rules 142 may, for example, be presented in the form of a table. A corresponding table can be as follows:

| Memory | |
|---|---|
| address/symbol | Rule |
| 0x8FFFF1234 mask | Access only through the function |
| 0xFFFFFF00 | “safe_data_lookup” |
| priv_key_RSA | Access only through the hardware security |
| | module |
| http_request_buffer | Access by “sanitize_http_request” |
| | before access by “eval_sql_request” |
| . . . | . . . |

The arrow in the direction from the host computer 136 to the hardware target 140 may describe a communication interface, in particular a conventional communication interface. The arrow pointing in the direction from the host computer 136 through the hardware debugger 138 to the hardware target 140 can describe the communication via the debugger. This can also apply accordingly to the opposite direction. The actual data flow to be examined by means of the taint analysis can take place on the hardware target 140.

1-16. (canceled)

17. A computer-implemented method for obtaining an access notification as part of a taint analysis when testing a software program, wherein the software program is executed on a hardware target, wherein the hardware target has a memory, wherein, during execution of the software program, the software program stores data at least in part of the memory, the method comprising the following steps:
generating input data for the software program using a test module;
transmitting the generated input data to the software program using the test module;
monitoring at least one address of the memory using a debugger while the software program at least partially processes the transmitted input data; and
transmitting an access notification to the test module when at least one access is detected at the at least one address of the monitored memory.

18. The method according to claim 17, wherein, to transmit the access notification to the test module, the method further comprises:
ascertaining status information of the hardware target using the debugger at a time at which access to the at least one address of the monitored memory is detected;
wherein the access notification includes the status information read by the debugger.

19. The method according to claim 18, wherein, to ascertain the status information of the hardware target, an access function that accesses the at least one address of the monitored memory is read out using the debugger, wherein the status information includes the access function.

20. The method according to claim 18, wherein, to ascertain the status information of the hardware target, a stack content of the hardware target is at least partially read out using the debugger, wherein the status information includes the partially read out stack content.

21. The method according to claim 20, wherein the partially read stack content includes an active stack frame.

22. The method according to claim 18, wherein, to ascertain the status information about the hardware target, the execution of the software program is stopped by using the debugger.

23. The method according to claim 17, wherein the at least one address of the memory corresponds to an address of the memory at which sensitive data are stored.

24. The method according to claim 17, wherein, to monitor the at least one address of the memory, one or more data watchpoints of the debugger are set at the at least one address of the memory.

25. The method according to claim 17, the method further comprising:
generating additional input data for the software program using the test module, taking into account the access notification transmitted to the test module;
transmitting the generated additional input data to the software program using the test module;
further monitoring the at least one address of the memory using the debugger while the software program at least partially processes the transmitted input data; and
transmitting a further access notification to the test module when at least one further access is detected at the at least one address of the monitored memory.

26. The method according to claim 17, wherein a test strategy of the test module is selected such that the test module generates the input data such that a data flow of sensitive data is maximized.

27. The method according to claim 25, the method further comprising:
determining whether a data security rule of the software program is violated by evaluating the access notification and/or the further access notification.

28. The method according to claim 17, the method further comprising:
aborting the method of obtaining an access notification as part of a taint analysis when testing a software program when at least one of the following conditions is met:
a violation of a data security rule of the software program was detected,
a software coverage of the software program has reached or exceeded a lower threshold value,
a specified number of input data were processed,
a specified test period has elapsed,
the method was aborted manually.

29. The method according to claim 17, wherein the test module includes a fuzzer, wherein the fuzzer generates the input data.

30. A system, comprising:
a host computer on which a test module is executed;
a hardware debugger on which a debugger is executed;
a hardware target which includes a microcomputer;
wherein the system is configured to execute a computer-implemented method for obtaining an access notification as part of a taint analysis when testing a software program, wherein the software program is executed on the hardware target, wherein the hardware target has a memory, wherein, during execution of the software program, the software program stores data at least in part of the memory, and wherein the the method includes the following steps:
generating input data for the software program using the test module;
transmitting the generated input data to the software program using the test module;
monitoring at least one address of the memory using the debugger while the software program at least partially processes the transmitted input data; and
transmitting an access notification to the test module when at least one access is detected at the at least one address of the monitored memory.

31. A computer-readable data carrier on which is stored a data structure, the data structure, after being loaded into a working and/or main memory of a system which includes:
a host computer on which a test module is executed,
a hardware debugger on which a debugger is executed, and
a hardware target which includes a microcomputer,
causes the system to execute a computer-implemented method for obtaining an access notification as part of a taint analysis when testing a software program, wherein the software program is executed on the hardware target, wherein the hardware target has a memory, wherein, during execution of the software program, the software program stores data at least in part of the memory, and wherein the method includes the following steps:
generating input data for the software program using the test module;
transmitting the generated input data to the software program using the test module;
monitoring at least one address of the memory using the debugger while the software program at least partially processes the transmitted input data; and
transmitting an access notification to the test module when at least one access is detected at the at least one address of the monitored memory.
